(19) United States
(12) Patent Application Publication
(10) Pub. No.: US 2011/0272190 A1
(43) Pub. Date: Nov. 10, 2011

(54) DAMAGE RESISTANT POWER TRANSMISSION STRUCTURES

(75) Inventors: JON MATTHEWS ROUSE, MADRID, IA (US); CASEY VAUGHN FABER, AMES, IA (US)

(73) Assignee: IOWA STATE UNIVERSITY RESEARCH FOUNDATION, INC., AMES, IA (US)

(21) Appl. No.: 13/100,334

(22) Filed: May 4, 2011

Related U.S. Application Data
(60) Provisional application No. 61/331,190, filed on May 4, 2010.

(51) Int. Cl. H02G 7/04

(52) U.S. Cl. 174/45 TD

(57) ABSTRACT

An overhead transmission line support structure includes a base segment and a main segment extending upwardly from the base segment. The overhead transmission line structure further includes a hinge operatively connecting the base segment with the main segment such that the hinge provides deflection capacity parallel to overhead transmission lines supported by the overhead transmission line support structure and such that with sufficient longitudinal loading on the overhead transmission line support structure, the main segment rotates about the hinge. The overhead transmission line support structure may include a post-tensioning system extending along the main segment and/or at least one fuse plate operatively connected between the base segment and the main segment and configured to deform upon the sufficient longitudinal loading on the overhead transmission line support structure.

### CROSS-REFERENCE TO RELATED APPLICATIONS

This application claims priority under 35 U.S.C. §119 to provisional application Ser. No. 61/331,190 filed May 4, 2010, herein incorporated by reference in its entirety.

### FIELD OF THE INVENTION

The present invention relates to damage resistant power transmission structures. More specifically, but not exclusively, the present invention relates to damage resistant power transmission structures which maintain maximum lateral load resistance over relatively large lateral deflections parallel to the attached wires.

### BACKGROUND OF THE INVENTION

Power transmissions structures are susceptible to progressive or cascading collapse stemming from a variety of catastrophic load events such as ice storms, extreme winds, impacts, ground movements, transmission line breaks, or sabotage. The power outages that result from such events impose significant costs on utilities and customers. Current structural design practice provides heavy, expensive dead-end structures spaced at approximately five to ten mile increments to contain a cascading collapse, thus sacrificing all the lighter structures in between. Thus, the direct and indirect costs associated with such collapses can be tremendous.

### BRIEF SUMMARY OF THE INVENTION

Therefore, it is a primary object, feature, or advantage of the present invention to improve over the state of the art.

It is a further object, feature, or advantage of the present invention to provide power transmission structures which are reliable.

A still further object, feature, or advantage of the present invention is to provide power transmission structures which are resistant to collapse.

Another object, feature, or advantage of the present invention is to provide power transmission structures which are economical to repair.

Yet another object, feature, or advantage of the present invention is to provide power transmissions structures which can be quickly and easily repaired.

A still further object, feature, or advantage of the present invention is to provide power transmission structures which isolate the effects of extreme load events.

Yet another object, feature, or advantage of the present invention is to eliminate dead-end structures.

A still further object, feature, or advantage of the present invention is to avoid cascading collapses of overhead transmission line structures.

Another object, feature, or advantage of the present invention is to provide overhead transmission line structures with high deflection capacity.

Yet another object, feature, or advantage of the present invention is to provide overhead transmission line structures which are of high stiffness.

Another object, feature, or advantage of the present invention is to provide overhead transmission line structures which can be quickly and economically erected by assembling the structure on the ground and rotating it up into its final position.

Yet another object, feature, or advantage of the present invention is to provide overhead transmission line structures which require less material and are thus more economical than currently used structures.

A further object, feature, or advantage of the present invention is to provide overhead transmission line structures which provide self-restoring forces once extreme loads are removed.

One or more of these and/or other objects, features, or advantages of the present invention will become apparent from the specification and claims that follow. No single embodiment need exhibit each and every object, feature, or advantage of the present invention. The present invention is not to be limited by these objects, features, or advantages.

According to one aspect of the present invention, an overhead transmission line support structure is provided. The overhead transmission line structure includes a base segment and a main segment extending upwardly from the base segment. The overhead transmission line structure further includes a hinge operatively connecting the base segment with the main segment such that the hinge provides deflection capacity parallel to overhead transmission lines supported by the overhead transmission line support structure and such that with sufficient longitudinal loading on the overhead transmission line support structure, the main segment rotates about the hinge.

According to another aspect of the present invention, a system includes a plurality of overhead transmission line structures. Each of the overhead transmission line structures includes a base segment, a main segment extending upwardly from the base, and a hinge operatively connecting the base segment with the main segment such that the main segment rotates about the hinge upon sufficient longitudinal loading. The system further includes transmission lines and/or shield wires supported by the overhead transmission line structures. Each of the overhead transmission line structures may further include a post-tensioning system extending along the main section. Each of the overhead transmission line structures may further include at least one fuse plate operatively connected between the base segment and the main segment.

According to another aspect of the present invention, a method of repairing an overhead transmission line structure is provided. The overhead transmission line structure includes a base segment, a main segment extending upwardly from the base segment a hinge operatively connecting the base segment with the main segment such that the hinge provides deflection capacity parallel to overhead transmission lines supported by the overhead transmission line support structure and such that with sufficient longitudinal loading on the overhead transmission line support structure, the main segment rotates about the hinge, and one or more fuse plates operatively connected between the base segment and the main segment and configured to deform plastically upon the sufficient longitudinal loading on the overhead transmission line support structure. The method includes removing the one or more fuse plates and replacing the one or more fuse plates.

According to another aspect of the present invention, an overhead transmission line support structure is provided. The overhead transmission line support structure includes a base segment, a main segment extending upwardly from the base segment, a hinge operatively connecting the base segment with the main segment such that the hinge provides deflection capacity parallel to overhead transmission lines, and a post-tensioning system connected to the main segment and the base segment or foundation.

According to another aspect of the present invention, an overhead transmission line support structure is provided. The overhead transmission line support structure includes a base segment, a main segment extending upwardly from the base segment, a hinge operatively connecting the base segment with the main segment such that the hinge provides deflection capacity parallel to overhead transmission lines, and at least one fuse plate operatively connected between the base segment and the main segment and configured to deform upon the sufficient longitudinal loading on the overhead transmission line support structure.

### BRIEF DESCRIPTION OF THE DRAWINGS

FIG. 1 is a perspective view illustrating one embodiment of an overhead transmission line support structure.

FIGS. 2A and 2B illustrate additional views of the hinge area of an overhead transmission line support structure of FIG. 1.

FIG. 3 illustrates top of pole lateral load versus deflection for one embodiment of the overhead transmission line support structure.

FIGS. 4A and 4B illustrate a system of multiple overhead transmission line support structures before an extreme load event (FIG. 4A) and after an extreme load event (FIG. 4B).

FIG. 5A-5C illustrate another embodiment of the structure.

FIG. 6 is a view showing the hinge region 18 in more detail.

FIG. 7 provides a different view of the base of the structure 10, especially the structural fuse plate 32.

FIG. 8A-8C illustrative examples of different types of mounting including use of baseplate or flange secured to a concrete foundation (FIG. 8A), embedding directly into a concrete foundation (FIG. 8B), and embedding the structure directly into the ground (FIG. 8C).

FIG. 9 and FIG. 10 illustrate the structure 10 after significant unbalanced longitudinal loading occurs.

FIG. 11A-11H illustrate an example of the structure 10 using another example of a hinge.

### DETAILED DESCRIPTION

The present invention provides for improved overhead transmission line support structures. Each typical line structure is designed to maintain all or most of its maximum lateral load resistance over much larger lateral deflections parallel to the lines than possible with current designs. Thus, a damaged structure may share loads with adjacent structures and isolate the effects of an extreme load event instead of initiating a cascading collapse. Furthermore, the present invention allows damaged structures to be quickly and easily repaired, thus greatly reducing costs associated with such events.

To attain the desired behavior, a pole system that employs elastic tendons and structural fuses is provided. The elastic tendons increase the overturning moment capacity of the structure and provide a self-centering force to right the pole when the extreme load is removed. The structural fuses are inexpensive, replaceable elements (such as external plates or bars) designed to form a plastic hinge under sufficient lateral load. The fuses serve to concentrate the damage in the fuse elements themselves and shield the rest of the structure from inelastic deformations. Thus, when the lateral load is removed the pole can right itself and repair can be achieved quickly and easily by simply replacing the structural fuses.

By slightly modifying current monopole details to accommodate the tendons and fuses, the incremental cost increase per pole could be limited and offset by the need for frequent dead-end structures. This structural system may be widely applicable and may significantly improve the reliability of the power transmission system.

The power transmission structure of the present invention is preferably designed to maintain all or most of its maximum lateral load resistance over a much larger lateral deflection than common designs in current use. The larger deflection capacity gives the system the ability to spread the lateral loading over multiple structures. As the first pole beyond a line break or significant unbalanced tension in the wires deflects, the lines attached in the other direction will sag reducing the tension force applied to the pole. This will cause unequal loading at the next pole, which will deflect to a lesser degree thereby helping to share the original load of the line break. This phenomenon will propagate down the line until the load has been redistributed throughout the system and equilibrium is once again achieved. Many poles share the load rather than one pole being forced to resist it alone.

The structure may also be quickly and easily repaired, with repair costs significantly lower than those associated with the replacement of current structures. Currently, there is no widespread standardization for deflection limits of structures leaving it up to the local utilities or design companies. For this reason, current structures are designed with a broad range of stiffness values. Flexible pole designs currently create issues during construction due to the complexity of the iterative tightening conductor procedure used. This method of tightening is complex because the camber of the pole must be calculated and each conductor must be tensioned to a different value because as the conductors in the first span are tensioned the pole will deflect and the lines that have been tightened will decrease in tension. As the conductors are tensioned in the second span the pole should be plumb and all lines should have the same tension, but often to achieve this the conductors in both spans must be adjusted.

The structure discussed here may be designed to achieve optimum behavior, having a high lateral stiffness and a high lateral deflection capacity. The structure employs post-tensioning and “structural fuses” to achieve this behavior. The post-tensioning system consists of high-strength internal elastic members. These post-tensioning members increase lateral stiffness, overturning moment capacity, and deflection capacity of the structure and provide a self-centering force to right the pole when the extreme load is removed. The structural fuses are inexpensive, replaceable elements designed to form a plastic hinge under sufficient lateral load. The fuses serve to concentrate the damage in the fuse elements while shielding the rest of the structure from inelastic damage. Thus, when the lateral load is removed the structure can right itself and repairs can be made quickly and easily by unbolting the old fuse plates and bolting on new structural fuses.

Current monopole designs need only be slightly modified to accommodate the post-tensioning system and fuses; the incremental cost increase per pole could be limited and offset because frequent dead-end structures would not be necessary. The joint where the fuses concentrate the damage can also be detailed to permit construction that is more efficient where less equipment would be necessary. Traditional monopole designs require a crane with high lighting capacity to raise the sections of the pole into place. The structures of the present invention may be largely assembled on the ground and once the hinge is connected raised into place by rotating about the hinge. Thus, equipment with small lifting capacity or a winch may be used instead of a crane. Once the pole is upright, the post-tensioning strands may be tightened and the structural fuses would be bolted in place and the conductors may be strung. The present invention is widely applicable and provides a much more sustainable option for power transmission systems.

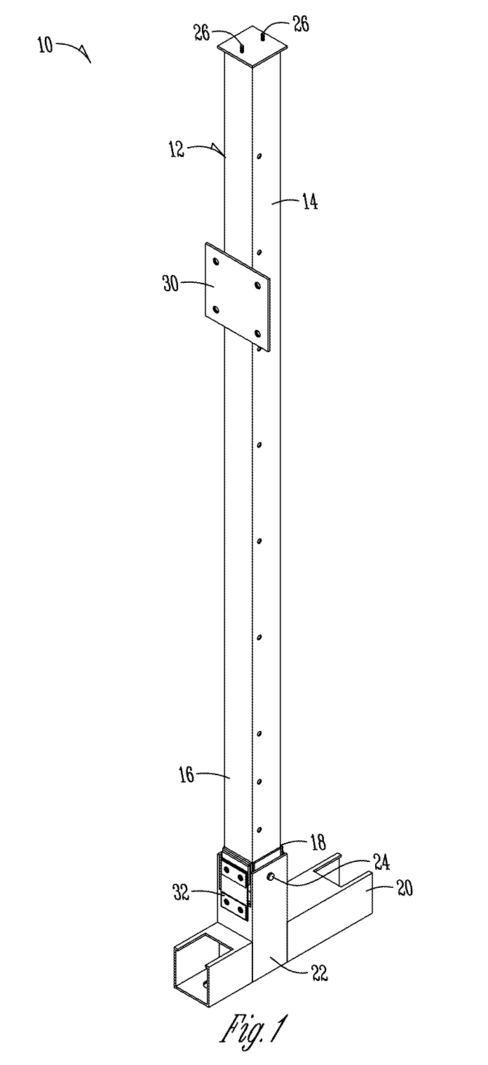

FIG. 1 illustrates one embodiment of a support structure of the present invention. In FIG. 1, a support structure 10 has a main segment 12. The main segment 12 may be formed of hollow structural steel (HSS), concrete, fiber reinforced polymer, or other metal. Where used, the HSS may be of standard square steel structure, although other geometries may be preferred. The main segment 12 has an upper portion 14 and a lower portion 16. The lower portion 16 of the main segment 12 is operatively connected with a hinge 18 to a base segment 22. The hinge is formed about a pin 24 connecting the lower portion 16 of the main segment 12 to the base segment 22. The hinge allows for large deflections parallel to the conductors. High deflection capacity can enable tangent structures to isolate damage and prevent a cascading collapse in the event of an extreme load. This feature allows multiple poles to act as a system to resist an unbalanced longitudinal load stemming from, for example, a conductor break. As the first poles adjacent to the conductor break deflect, the attached lines will sag reducing the longitudinal force applied to the pole. This will cause unbalanced loading on the next pole, which will deflect to a lesser degree helping to share the original load of the line break. Such behavior will propagate down the line until the load has been redistributed throughout the system and equilibrium is reached.

Elastic post-tensioning members 26 are shown extending along the main segment 12. These post-tensioning members 26 may be high strength threaded rods or cables. These elastic members used as post-tensioning give the structure 10 added strength and stability. The post-tensioning members may be internal or external to the main segment 12 of the structure 10. The structure's stiffness is increased by the elastic tendons. Because the tendons remain elastic they do not need to be replaced if the structure does experience large deflections. The post-tensioning also helps provide a restoring force to the structure once the unbalanced line loads are removed.

One or more fuse plates 32 are operatively connected between the main segment 12 and the base segment 22 at a slip resistant bolted and/or welded connection. Each of the fuse plates may be made of A36 steel or similar material. Each fuse plate may be sized such that as the main segment rotates about the hinge due to longitudinal loading, plastic deformation is confined to at least one fuse plate. The fuse plates 32 are used as structural fuses to connect the segments of the monopole and provide stability to the hinge region. During an extreme load event when the structure 10 experiences large deflections and rotates about the hinge, plastic deformation is isolated at the fuse plates 32. The plates are inexpensive, easy to inspect and replace, and shield the rest of the pole from damaging stresses.

A load plate 30 is shown. The load plate 30 shown is associated with experimental testing. In use, the load plate 30 would be provided by transmission lines.

The base segment 22 may be connected to a concrete foundation with a base plate 20 or flange along with embedded bolts. Alternatively, the base segment 22 may be embedded directly into a concrete foundation or the ground.

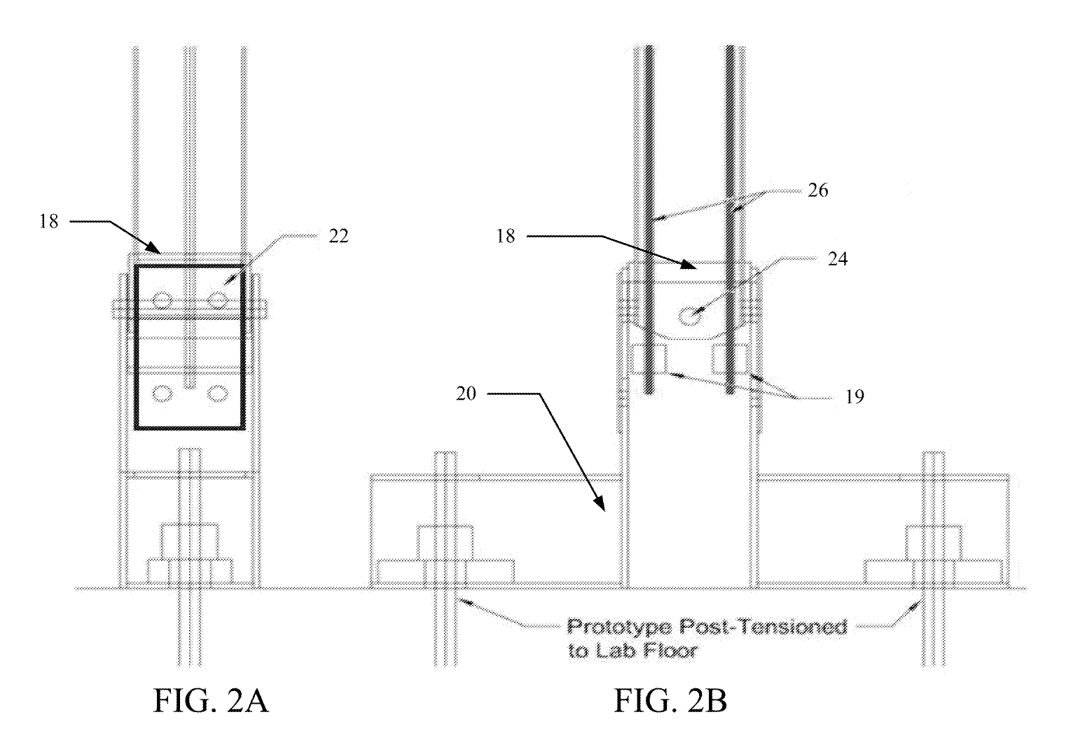

FIG. 2A and FIG. 2B provide additional schematics for the transmission line support structure. In FIG. 2B post tensioning blocks 19 are shown which are used in mounting the post tensioning rods 26 in one form of a post tensioning system. As previously explained, instead of using rods 26, cables may be used instead. Alternatively, the post-tensioning system could be connected directly to a concrete foundation with anchors embedded in the concrete.

The present invention provides various advantages. For example, the structure may increase reliability by eliminating cascading collapse phenomena. The structure may reduce system-wide vulnerability by isolating damage from catastrophic loads to a small number of poles near the event.

Another benefit is that the structure may lower cost of repairs. Rather than replacing the entire structure, only the structural fuses that have experienced plastic deformation would need to be replaced. The entire system may be able to be constructed at a lower cost than current systems by requiring fewer expensive dead-end structures. Lighter tangent structures may be used due to the lower consequence of failure gained from the large longitudinal deflection capacity and load sharing capability of the system.

Additional cost savings may be generated during construction. Rather than requiring large cranes (and the associated costs of transporting cranes to remote locations), the pole may be constructed entirely on the ground and tilted up into place about the hinge such as by using a winch. These cost savings may offset any extra fabrication costs associated with the hinge region of the structure.

A prototype was constructed and tested. The prototype was a one-fifth scale design based on a monopole example in ASCE 72. The test specimen was constructed from hollow steel sections. Both high-strength threaded rods and high-strength cable were tested as post-tensioning methods.

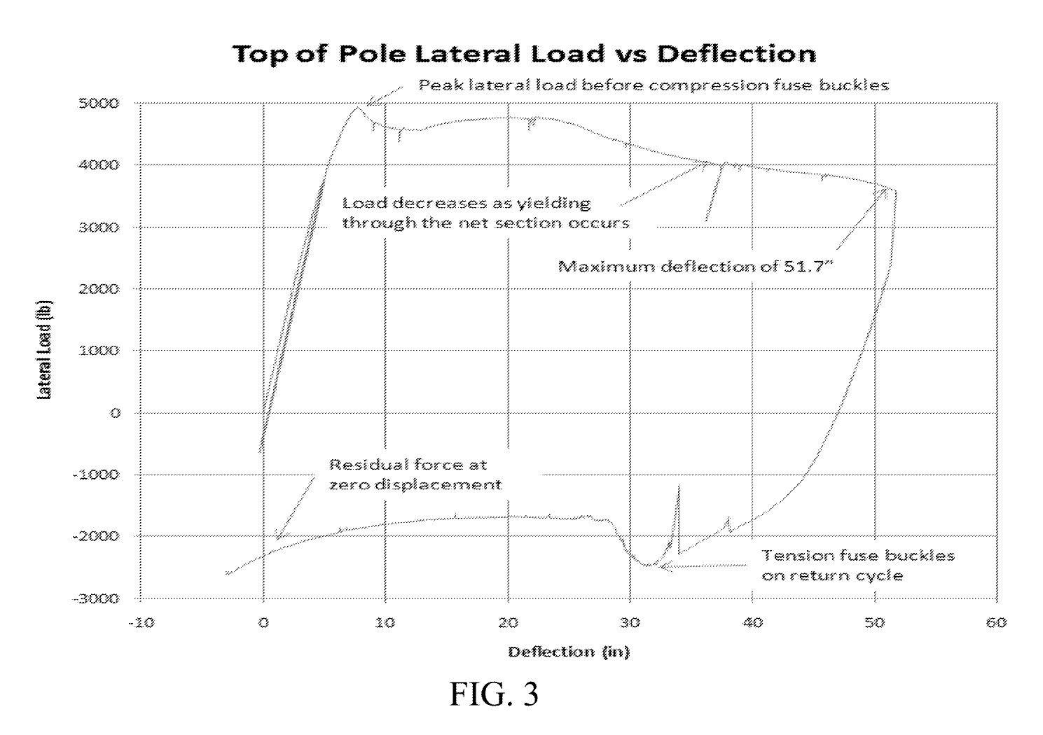

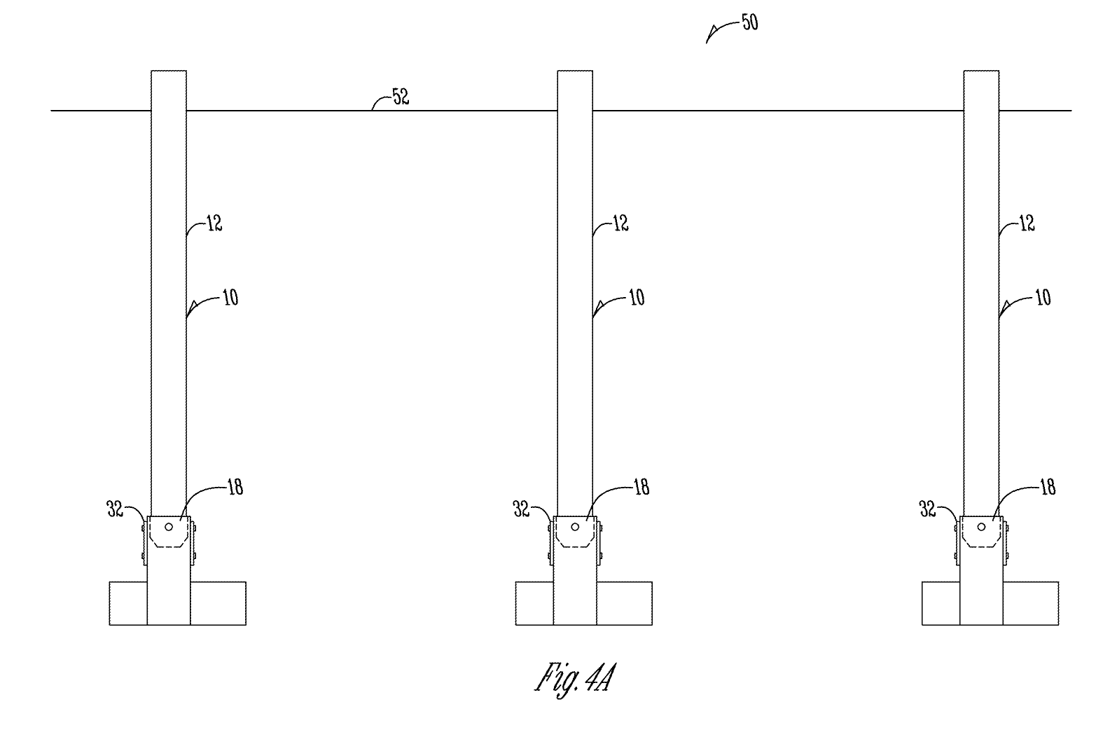

Monotonic lateral load tests were performed on the structure while load, deflection, and strain data were recorded. The structure achieved a maximum deflection of 51.7 inches (22.7% drift) while maintaining over 75% of the design load before fracture of the fuse plate. At 24 inch deflection (10% drift) the structure still maintained 100% of design strength. Test data is shown in FIG. 3. Such performance is easily sufficient to allow load sharing among structures during extreme events and achieve the system advantages previously described.

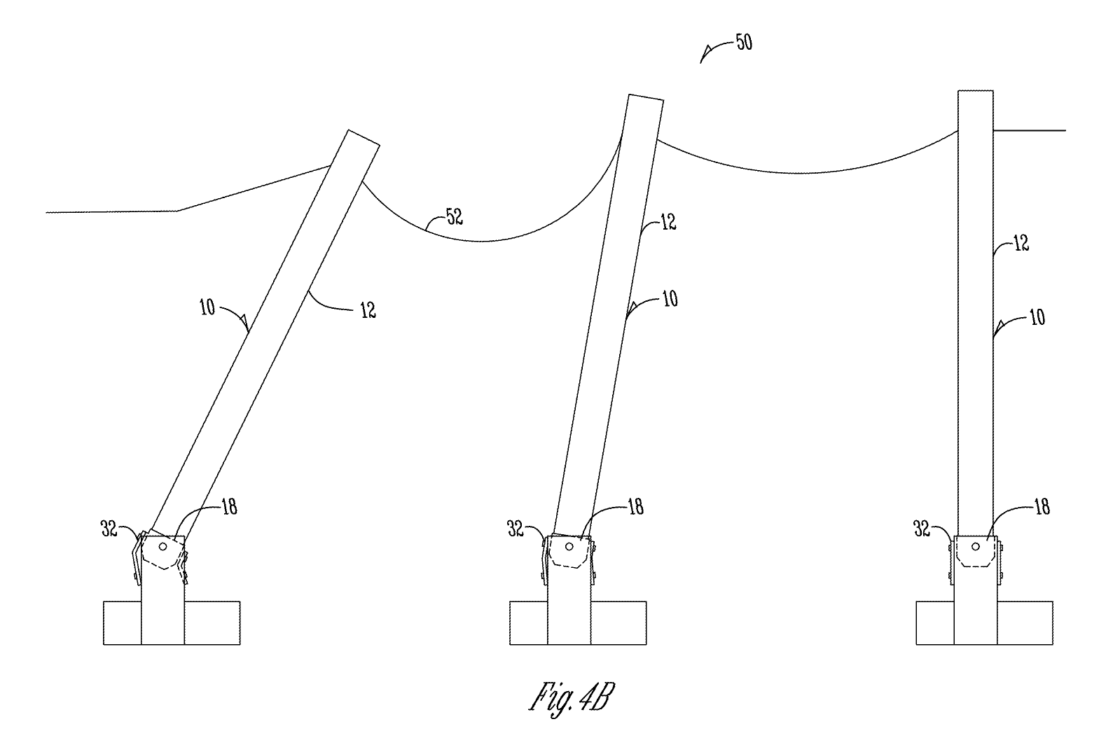

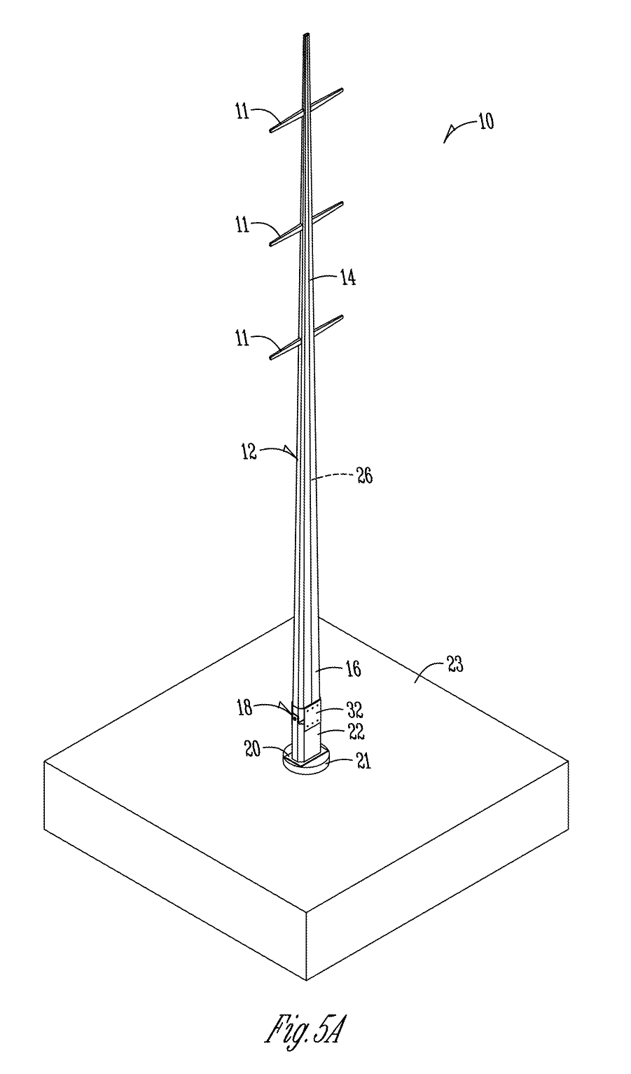

FIG. 4A and FIG. 4B illustrate one example of a system 50 which includes a plurality of structures 10. In FIG. 4A the system is shown in a normal state with transmission lines 52 being supported by the structures 10. FIG. 4B illustrates the system 50 after significant unbalanced longitudinal loading occurs. The loading may be caused by any number of events such as, without limitation, ice storms, extreme winds, impacts, ground movements, transmission line breaks, or sabotage. When the significant loading occurs, the main segment 12 of each structure 10 rotates about the corresponding hinge due to longitudinal loading. Plastic deformation occurs but is confined to the structural fuse plates 32. The structural fuse plates 32 yield in tension and buckle in compression as the monopole structures 10 undergo large deflection. The tension side fuse plate in combination with the post-tensioning provides the lateral load resistance of the structures 10. Rotation about the hinge is limited only by the ultimate elongation of the tension side fuse plate.

Thus, the structure 10 allows for reduction of system-wide vulnerability by isolating damage from the catastrophic event. After the catastrophic event, the structures 10 may be repaired by removing any deformed structural fuse plates, rotating the structure to the upright position and replacing the structural fuse plates. Thus, the present invention provides for a simplified process or repair.

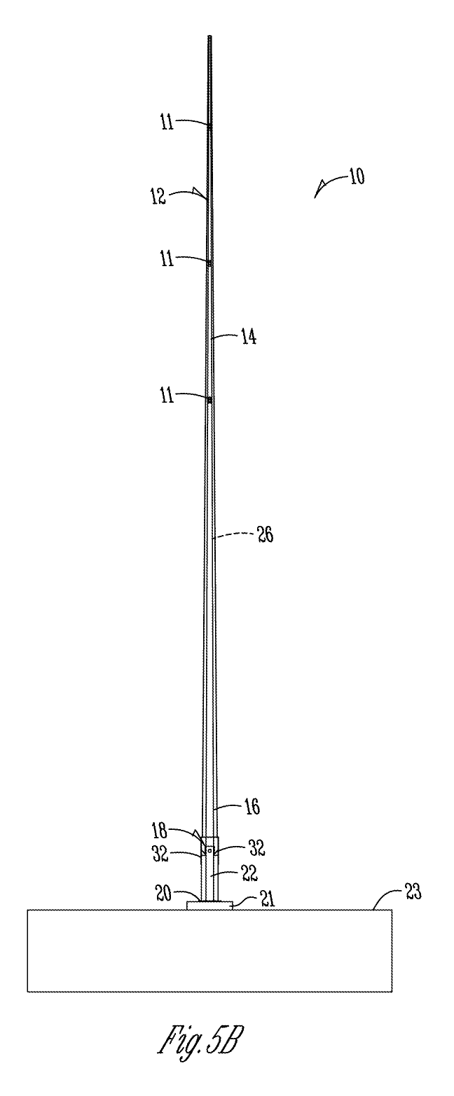

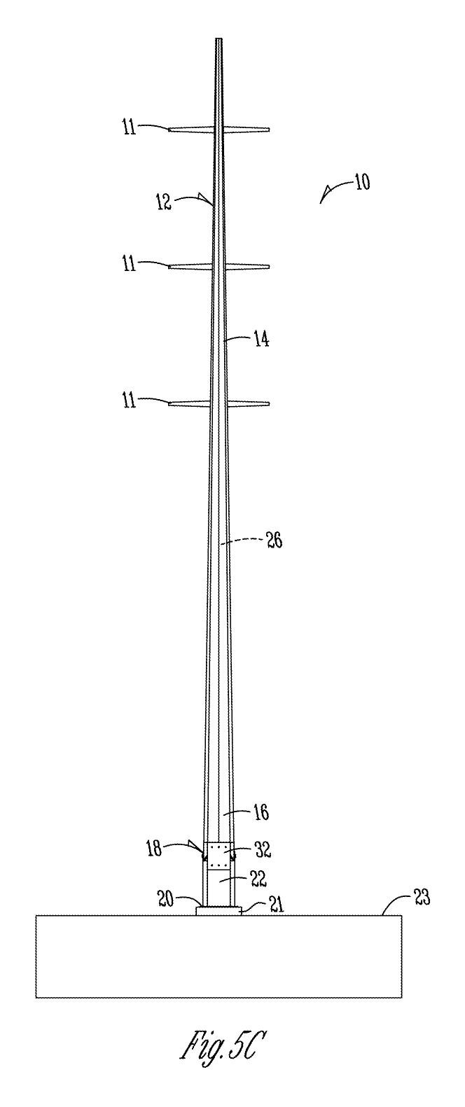

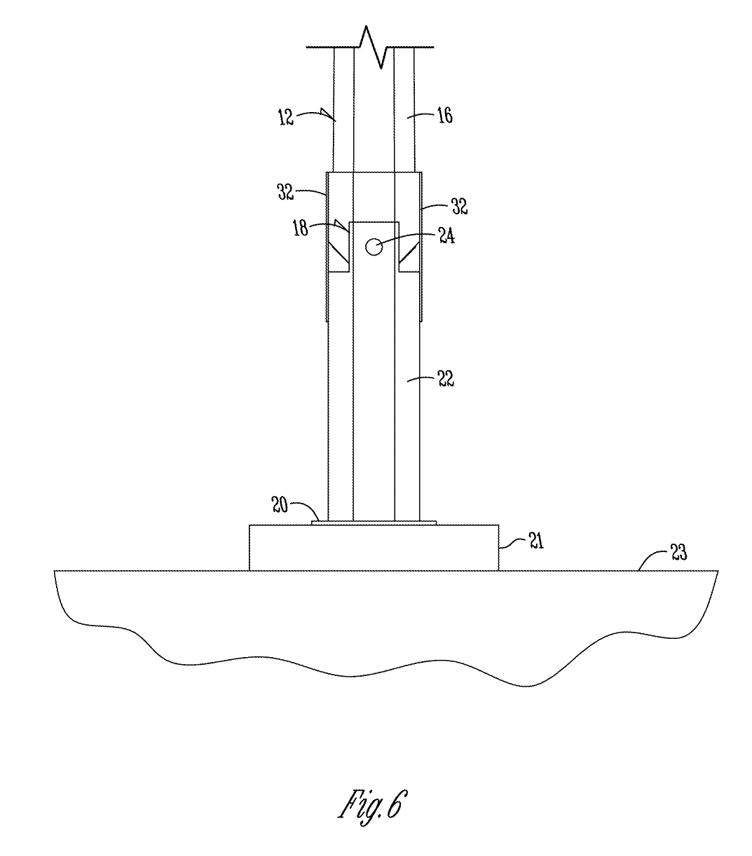

FIG. 5A-5C illustrate another embodiment of the structure 10. As shown in FIG. 5A, 5C, the structure 10 has a plurality of cross members 11 which may be used for supporting overhead transmission lines. The structure 10 is also shown as secured to the ground 23, such as with the base segment 22 being connected to a concrete foundation 21 with a base plate or flange 20 along with embedded bolts.

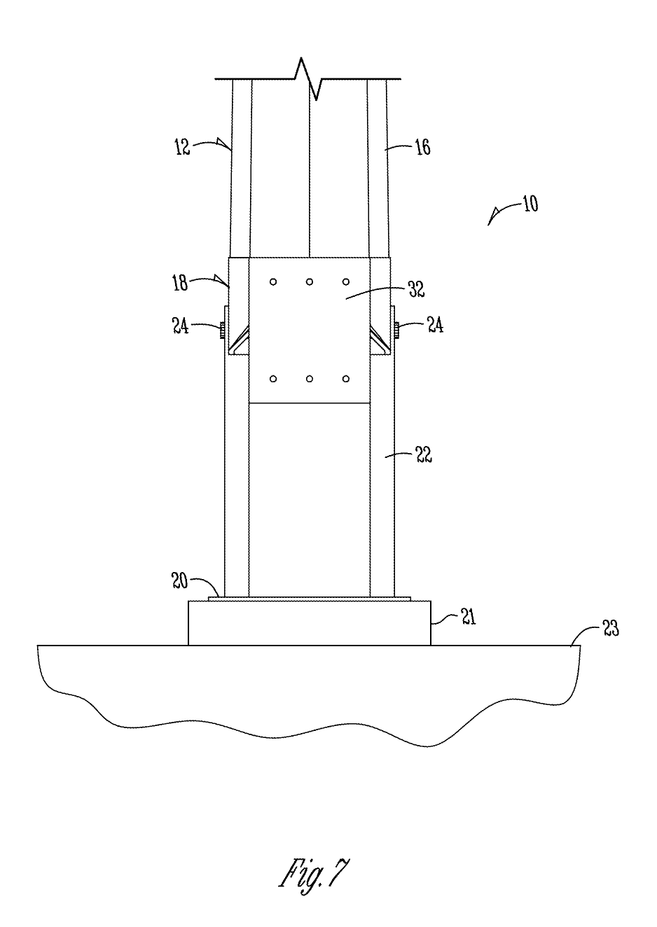

FIG. 6 is a view showing the hinge 18 in more detail. A first and a second base plate are shown which operatively connect the main segment 12 to the base segment 22. Also FIG. 6 shows the structure 10 being secured to the ground 23 with a base segment 22 being connected to a concrete foundation 21 with a base plate or flange 20.

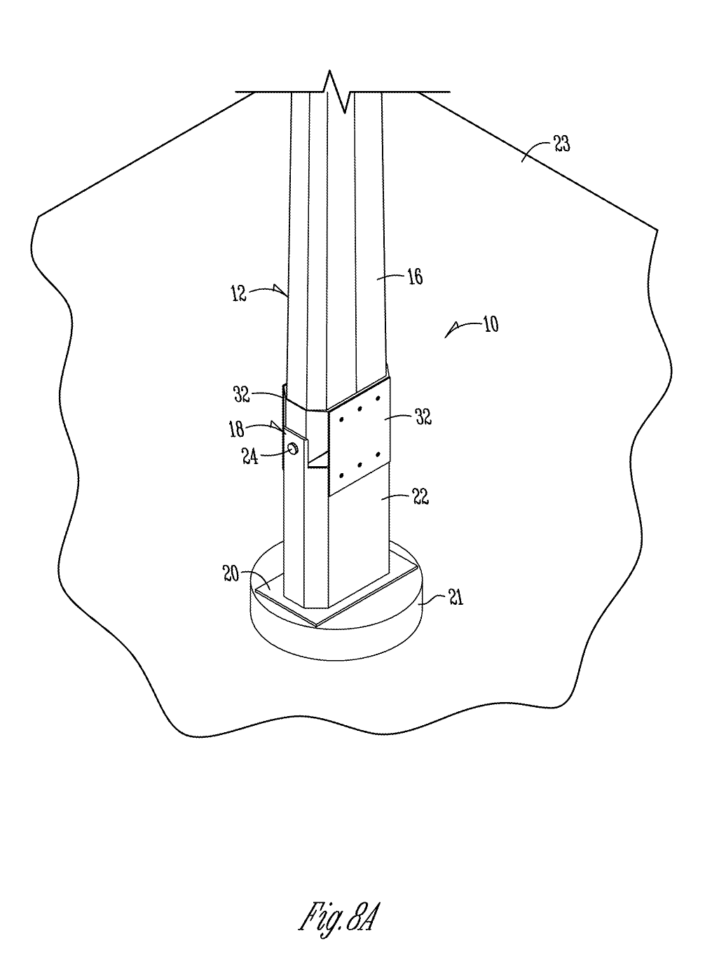

FIG. 7 provides a different view of the base of the structure 10, especially the structural fuse plate 32.

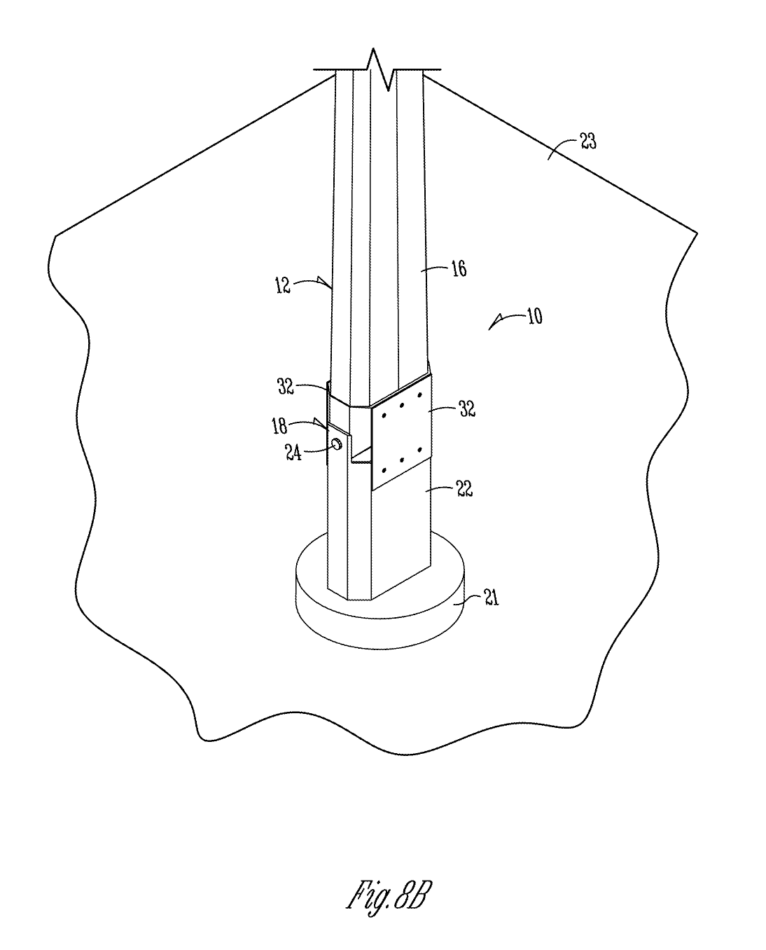

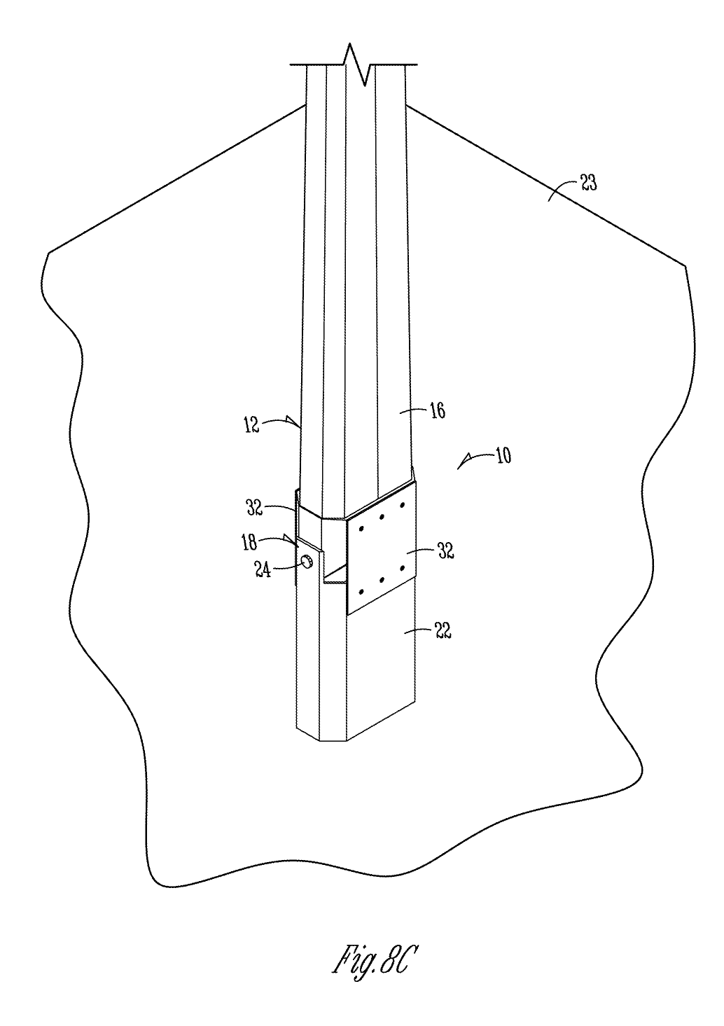

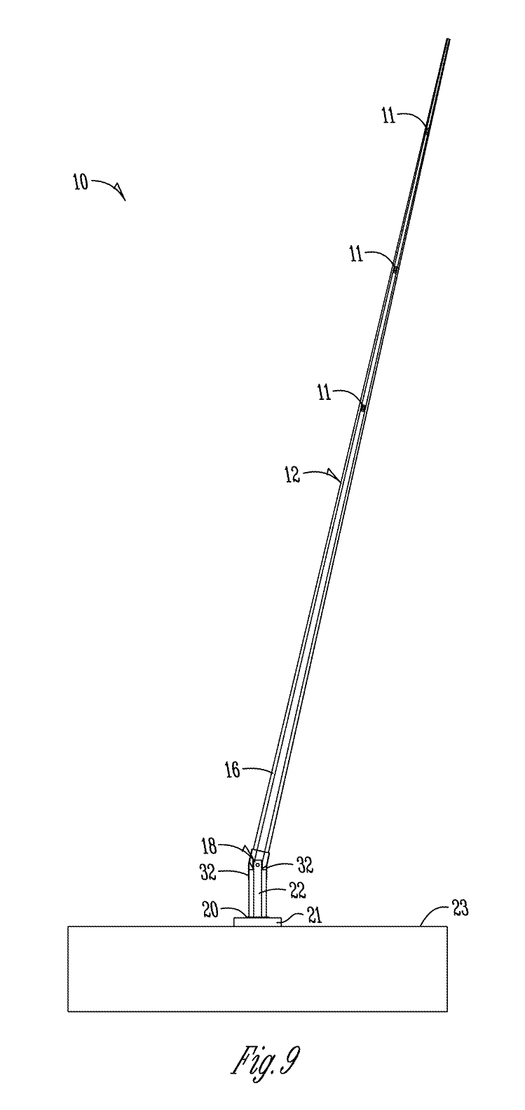

FIG. 8A provides a different view of the base of the structure 10, shown with the base plate or flange 20 secured to a concrete foundation 21. FIG. 8B illustrates the structure 10 being embedded directly into a concrete foundation 21. FIG. 8C illustrates the structure 10 being embedded directly into the ground.

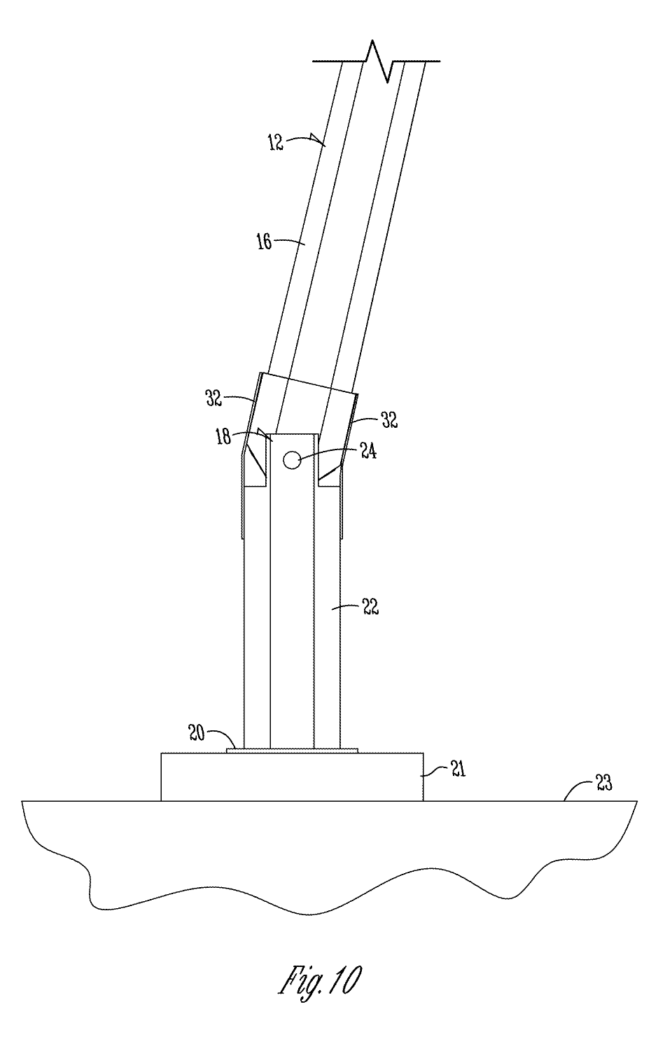

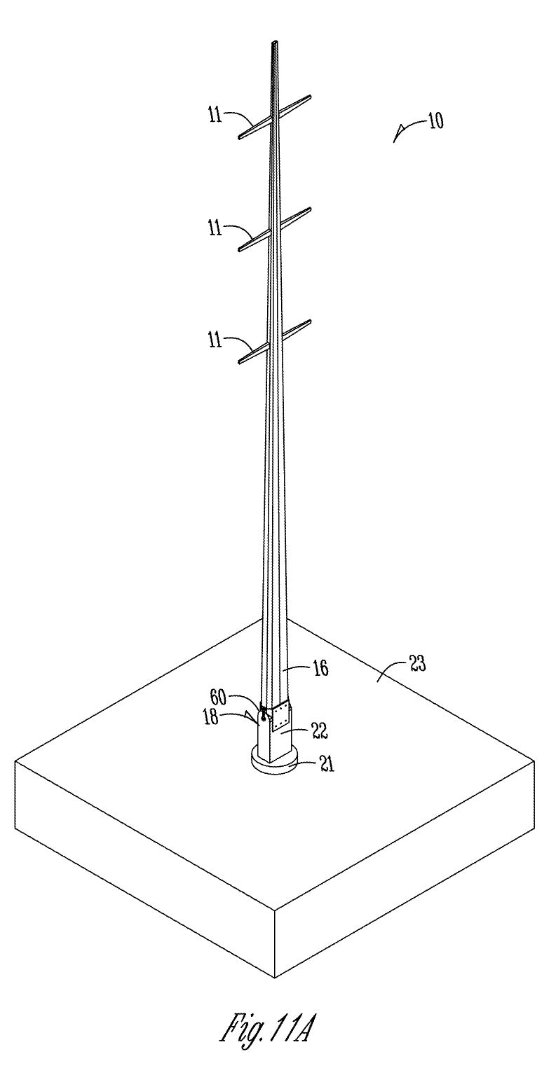

FIG. 9 and FIG. 10 illustrate the structure 10 after significant unbalanced longitudinal loading occurs. Note that the main segment 12 is rotated about the hinge 19 due to the longitudinal loading and plastic deformation is confined to the structural fuse plates 32.

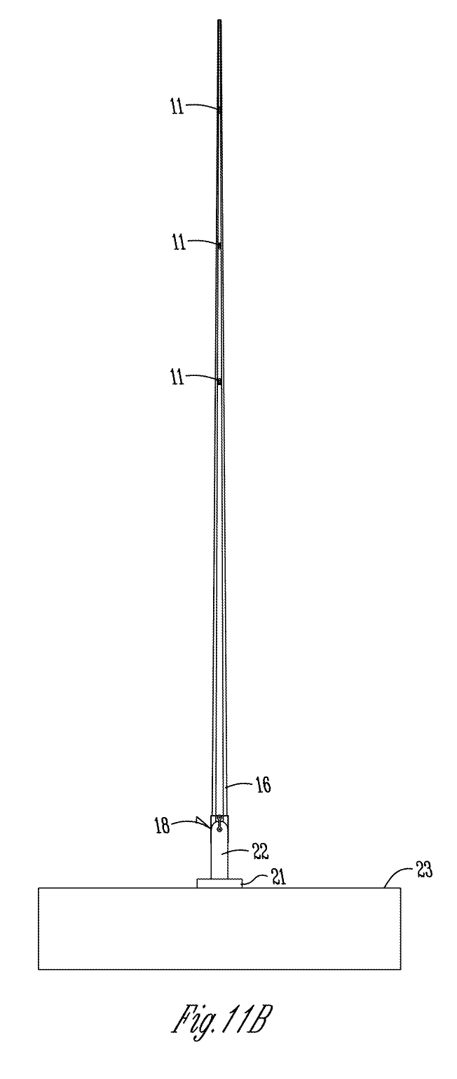

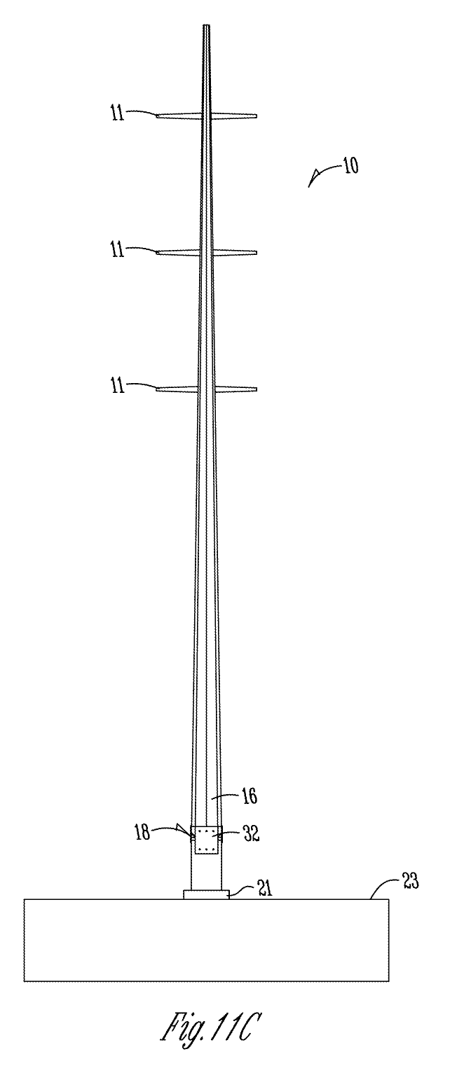

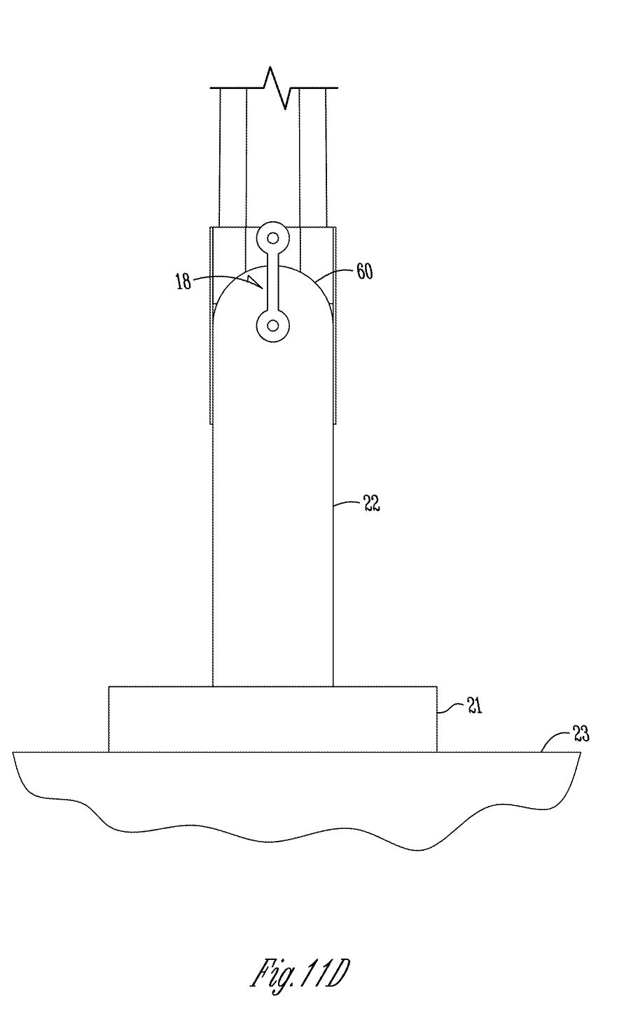

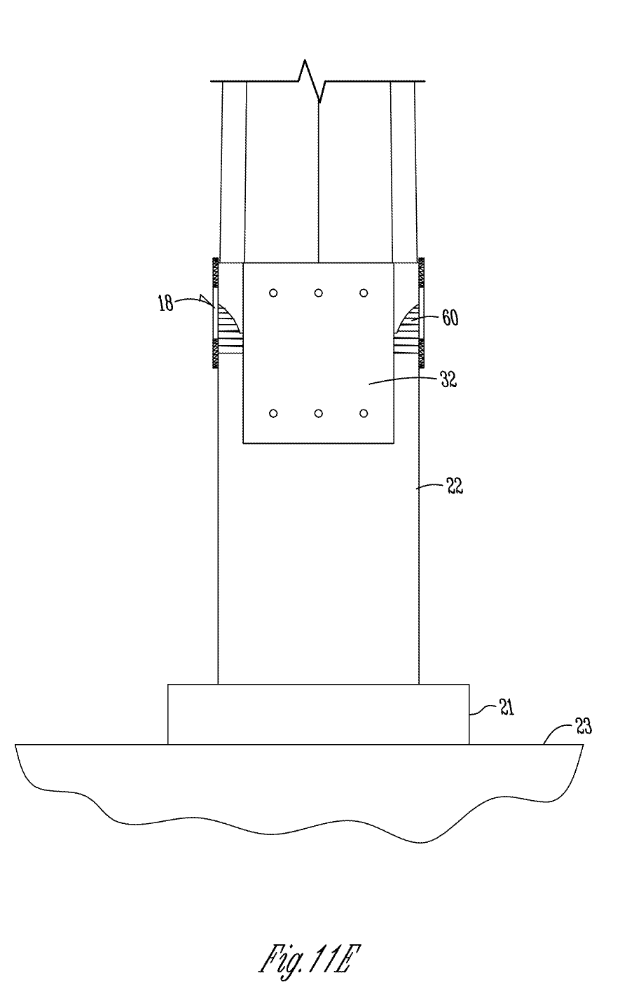

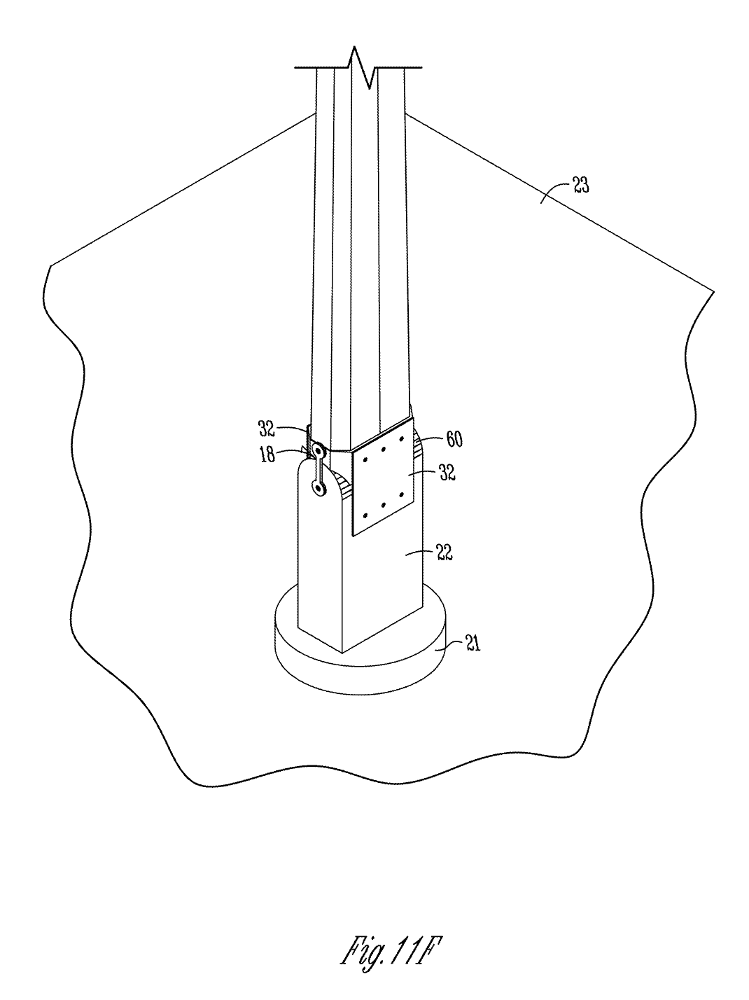

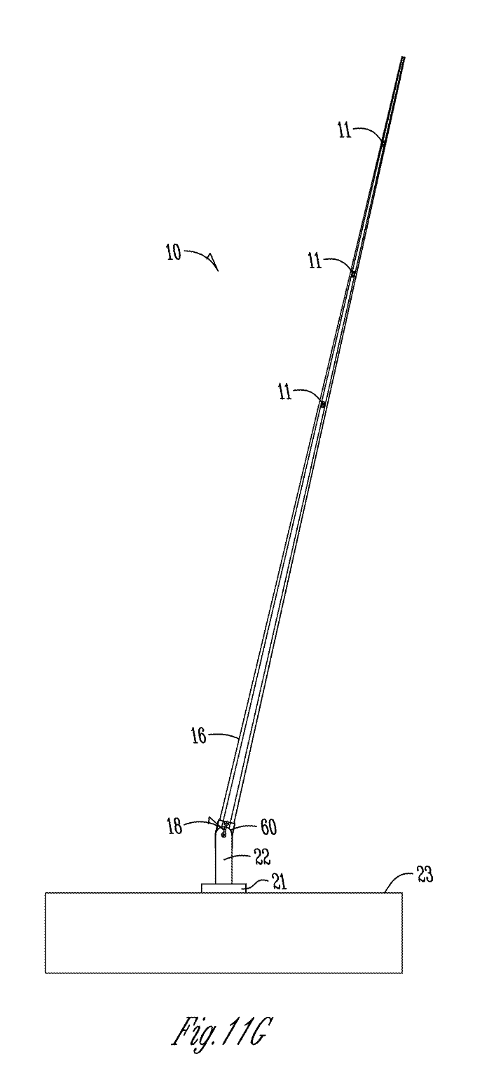

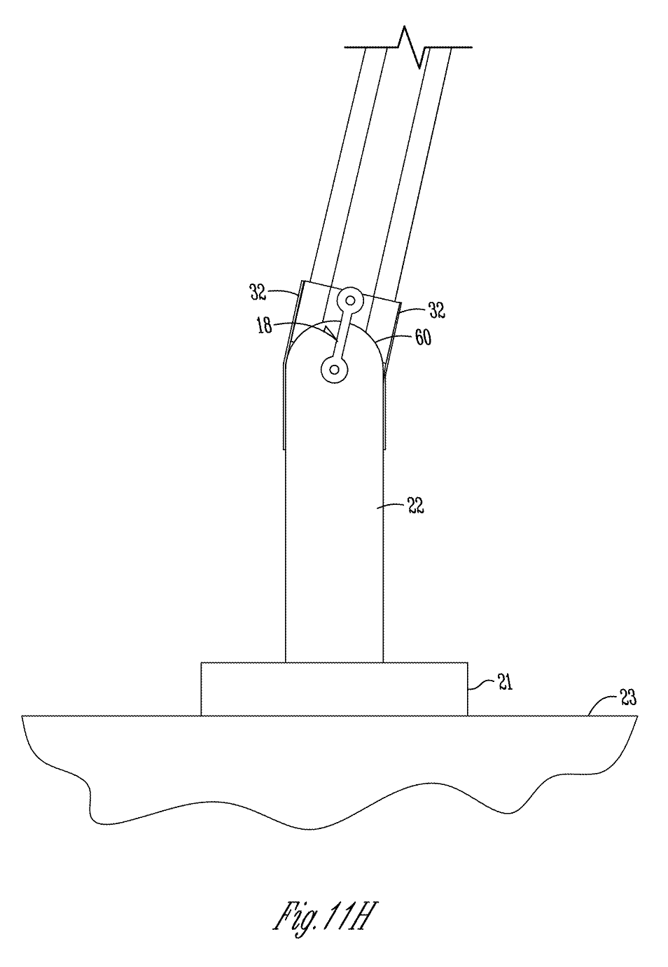

FIG. 11A-11H illustrate an example of the structure 10 using another example of a hinge. As shown in FIG. 11A-11H, an alternative hinge style may be used where the base segment 22 is cast of concrete with a concave top surface 60 upon which the main segment 12 may rotate.

Therefore damage resistant power transmission structures and related systems and methods have been disclosed. The present invention contemplates numerous variations, options, and alternatives. For example the present invention contemplates variations in the type of material of the monopole, type of material of the base segment, the configuration of the hinge, the manner in which the structure is secured to the ground, the shape of the monopole, the type of material of the structural fuse plates, the number of structural fuse plates, the structure of the elastic tendons, whether the elastic tendons are interior or exterior to the structure (if used), the type of base, whether or not a post tensioning system is used, whether or not structural fuse plates are used, and other variations, options and alternatives in the structure and its configuration. Although various embodiments have been shown or described, the present invention is not to be limited to the specific embodiments described herein.

What is claimed is:

1. An overhead transmission line support structure comprising:
a base segment;
a main segment extending upwardly from the base segment;
a hinge operatively connecting the base segment with the main segment such that the hinge provides deflection capacity parallel to overhead transmission lines supported by the overhead transmission line support structure and such that with sufficient longitudinal loading on the overhead transmission line support structure, the main segment rotates about the hinge.

2. The overhead transmission line support structure of claim 1 further comprises a post-tensioning system operatively connected to the main segment and the base segment or a foundation.

3. The overhead transmission line support structure of claim 1 wherein the post-tensioning system comprises at least one post-tensioning rod.

4. The overhead transmission line support structure of claim 1 further comprising at least one fuse plate operatively connected between the base segment and the main segment and configured to deform upon the sufficient longitudinal loading on the overhead transmission line support structure.

5. The overhead transmission line support structure of claim 4 wherein each of the at least one fuse plate is a steel plate.

6. The overhead transmission line support structure of claim 1 further comprising a pin in the hinge.

7. The overhead transmission line support structure of claim 1 further comprising at least one transmission line supported along an upper portion of the main segment.

8. The overhead transmission line support structure of claim 1 wherein the base segment is attached to a base plate or flange secured to concrete.

9. The overhead transmission line support structure of claim 1 wherein the base segment is secured through embedment in concrete or ground.

10. The overhead transmission line support structure of claim 1 wherein the base segment being formed from concrete.

11. A system comprising:
a plurality of overhead transmission line structures wherein each of the overhead transmission line structures comprises (a) a base segment, (b) a main segment extending upwardly from the base, and (c) a hinge operatively connecting the base segment with the main segment such that the main segment rotates about the hinge upon sufficient longitudinal loading;
transmission lines supported by the overhead transmission line structures.

12. The system of claim 11 wherein each of the overhead transmission line structures further comprises a post-tensioning system extending along the main section.

13. The system of claim 12 wherein the post-tensioning system comprises a plurality of rods or cables.

14. The system of claim 12 wherein the post-tensioning system further comprises a plurality of blocks, each of the plurality of rods secured to one of the plurality of blocks.

15. The system of claim 12 wherein the post-tensioning system is secured to anchors embedded in a concrete foundation.

16. The system of claim 11 wherein each of the overhead transmission line structures further comprises at least one fuse plate operatively connected between the base segment and the main segment.

17. The system of claim 16 wherein each of the at least one fuse plate is a metal plate.

18. The system of claim 16 wherein each of the main segments is formed from metal, concrete, or fiber re-inforced polymer.

19. The system of claim 11 wherein each base segment is formed from concrete.

20. A method of repairing an overhead transmission line structure comprising (a) a base segment, (b) a main segment extending upwardly from the base segment, (c) a hinge operatively connecting the base segment with the main segment such that the hinge provides deflection capacity parallel to overhead transmission lines supported by the overhead transmission line support structure and such that with sufficient longitudinal loading on the overhead transmission line support structure, the main segment rotates about the hinge, and (e) one or more fuse plates operatively connected between the base segment and the main segment and configured to deform upon the sufficient longitudinal loading on the overhead transmission line support structure, the method comprising:
removing the one or more fuse plates; and
replacing the one or more fuse plates.

21. The method of claim 20 further comprising hingably rotating the main segment into a substantially upright position.

22. An overhead transmission line support structure comprising:
a base segment;
a main segment extending upwardly from the base segment;
a hinge operatively connecting the base segment with the main segment such that the hinge provides deflection capacity parallel to overhead transmission lines; and
a post-tensioning system operatively connected to the main segment and the base segment or a foundation.

23. An overhead transmission line support structure comprising:
a base segment;
a main segment extending upwardly from the base segment;
a hinge operatively connecting the base segment with the main segment such that the hinge provides deflection capacity parallel to overhead transmission lines; and
at least one fuse plate operatively connected between the base segment and the main segment and configured to deform upon sufficient longitudinal loading on the overhead transmission line support structure.
